(19) United States
(12) Patent Application Publication
(10) Pub. No.: US 2019/0010796 A1
(43) Pub. Date: Jan. 10, 2019

(54) UNDERWATER GAS/LIQUID-LIQUID METHOD AND SEPARATION SYSTEM AND USE OF DEOLING MEMBRANE

(71) Applicant: General Electric Company, Schenectady, NY (US)

(72) Inventors: Alexandre Mussumeci Valim DE FREITAS, Rio de Janeiro (BR); Marcelo ANDREOTTI, Rio de Janeiro (BR)

(21) Appl. No.: 16/067,225

(22) PCT Filed: Dec. 29, 2016
(86) PCT No.: PCT/US2016/069119

§ 371 Date: Jun. 29, 2018

(30) Foreign Application Priority Data
Dec. 30, 2015 (BR) 102015033000-6

(51) Int. Cl. E21B 43/36

(52) U.S. Cl. CPC E21B 43/36; C02F 1/40

(57) ABSTRACT

Embodiments of the present invention relate to an underwater gas/liquid-liquid modular separation system which enables the disposal of produced water in undersea environment. The underwater gas/liquid-liquid modular system separation consists of a gravitational separator and a water polishing system consisting of deoiling membranes capable of withdrawing the residual oil contained in water. Furthermore, the underwater gas/liquid-liquid modular separation system also features a demulsifier injection which promotes the breakdown of the water-oil emulsion. Embodiments further relate to an underwater gas/liquid-liquid separation method and to the use of deoiling membranes in gas/liquid-underwater liquid separation systems.

### BACKGROUND

Embodiments of the present invention herein relate to a modular underwater gas/liquid-liquid separation system which allows for the disposal of water produced in an underwater environment. The modular underwater gas/liquid-liquid separation system is composed of a gravitational separator and a water polishing system consisting of deoiling membranes capable of withdrawing the residual oil contained in the water. In addition, the modular underwater gas/liquid-liquid separation system also features a demulsifier injection which promotes the breakdown of the water-oil emulsion.

Embodiments further relate to an underwater gas/liquid-liquid separation method and to the use of deoiling membranes in underwater gas/liquid-liquid separation systems.

The features of offshore oil production make the underwater Primary Petroleum Processing (PPP) project challenging. Heavy oil and water quality to be reinjected or discarded requires technologies that are at the frontier of knowledge.

Thus, due to these peculiar features of petroleum, the performance of the separation systems is often not satisfactory and as a result, the quality of treated water does not meet the legal requirements established by the CONAMA 393 resolution or the project.

A number of separation systems are described in the state of the art. For example, the document US20130026082 discloses a dynamic water/oil demulsifier system including an in-line microwave treatment subsystem, sensors that monitor and transmit data corresponding to the properties of the water-oil emulsion, and a processor/controller which initiates the application of microwave energy to the emulsion(s) based on the sensor data is known in the art.

The document US20130327726 discloses a method and apparatus for separating a multiphase fluid stream, in particular, suitable for separating oil droplets from water.

The document US20140196902 describes a method, system, and composition for the production of oil from a formation, using oil recovery formulation. In turn, the document US20140038858 discloses an improved oil recovery formulation composition containing a sacrificial agent and a tensor-active dispersed in a fluid. According to such documents, the separation unit may comprise a conventional liquid-gas separator; and a conventional hydrocarbon-water separator, wherein the hydrocarbon-water separator may comprise a demulsifier.

The document US20140042058 refers to a process for the production and separation of oil, wherein a demulsifier and a brine solution are mixed with the oil and water produced from the formation.

The system for producing and separating oil described in the document US20140041856 comprises an oil formation, a low salinity aqueous fluid, a brine solution, and a demulsifier, wherein, in an alternative embodiment of the system, the demulsifier is introduced into the production well.

In Frising et al. (The Liquid/Liquid Sedimentation Process: From Droplet Coalescence to Technologically Enhanced Water/Oil Emulsion Gravity Separators: A Review, Journal of Dispersion Science and Technology, Volume: 27, Issue: 7, 2006), technological improvements are presented used to accelerate and/or increase the separation (heating, chemical demulsifiers, mechanical barriers, electrocoalescence, ultrasound, microwave).

A gas/water-oil separation method for the Marlim-RJ field was developed by Petrobrás, in partnership with FMC Technologies, using hydrocyclones (deoilers-oil removers) to separate the residual oil dispersed in the aqueous phase and thus obtain water with a TOG content (oil and total grease) within the design requirements.

The underwater separation systems on the market have hydrocyclone units (de-oilers) to promote the separation of dispersed oil in the aqueous phase, and to “match” the TOG (Total Oil and Grease) of the aquase phase into compatible discard or reinjection. This device is a simple and robust static machine, but its performance is subject to the control/stability of several variables such as: density and viscosity of continuous liquid phase, operating temperature, inlet pressure, dispersed oil droplet concentration and size of these oil droplets. As a consequence, fluctuations in the inlet pressure and in the concentration and size of the oil droplets, which are not uncommon to occur in an underwater separation system, will have a direct impact on the quality of the water coming out of the hydrocyclone.

Thus, despite the attempts, the difficulty remains of efficient separation of Brazilian oil, providing quality to the water according to the legal requirements established by the CONAMA 393 resolution or the project.

It is worth mentioning that in reservoirs where the re-injection of treated water in the process is not possible, water must be discarded or a dedicated new well must be drilled exclusively for the disposal of the water, which raises the costs of the project.

Advantageously, the preparation of treated water with compatible quality to the environmental legislation allows its disposal at sea and is therefore more financially favorable when compared to processes where water must be reinjected in the process or sent to a dedicated well to the disposal of process water.

Thus, in view of the great need for an efficient gas/liquid-liquid separation system for strong emulsions, such as the Brazilian oil, and the need for alternatives that provide treated high purity water for disposal at sea, the inventors have developed a modular and robust subsea gas/liquid-liquid separation system comprising de-emulsifiers, gravitational separator and deoiling membranes.

### BRIEF DESCRIPTION OF THE DRAWINGS

The subject matter which is regarded as the invention is particularly pointed out and distinctly claimed in the concluding part of the specification. Embodiments of the invention, however, may be best understood by reference to the following description taken in conjunction with the accompanying drawing figures in which:

FIG. 1A schematically illustrates the primary underwater oil processing of an embodiment of the underwater gas/liquid-liquid modular separation system of the invention;

FIG. 1B schematically illustrates the primary underwater oil processing of an embodiment of the underwater gas/liquid-liquid modular separation system of the invention comprising the TOG online sensor;

FIG. 2 illustrates details of a gravitational separator useful in the invention herein;

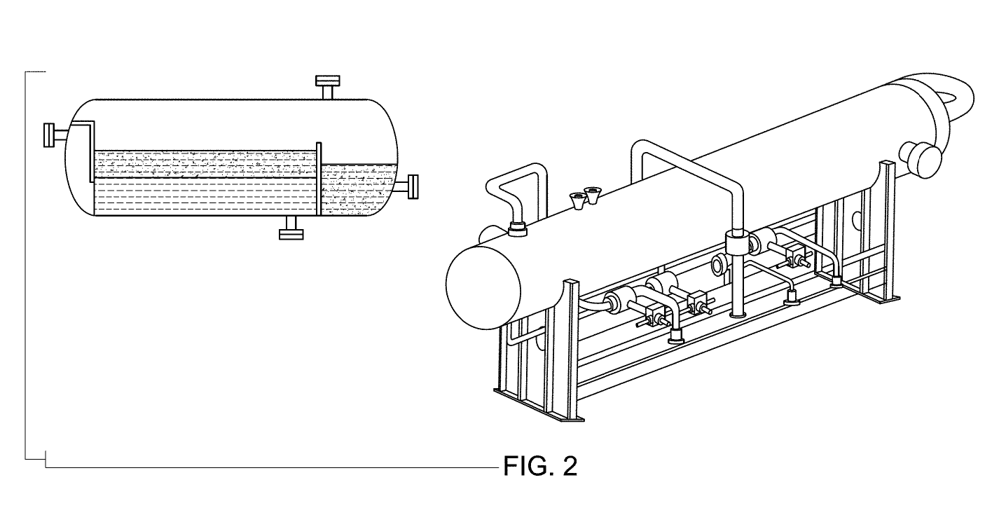

FIG. 3A illustrates details of a deoiling membrane element useful in the invention herein, and FIG. 3B illustrates a possible pool assembly of the membrane that can be installed on the seabed;

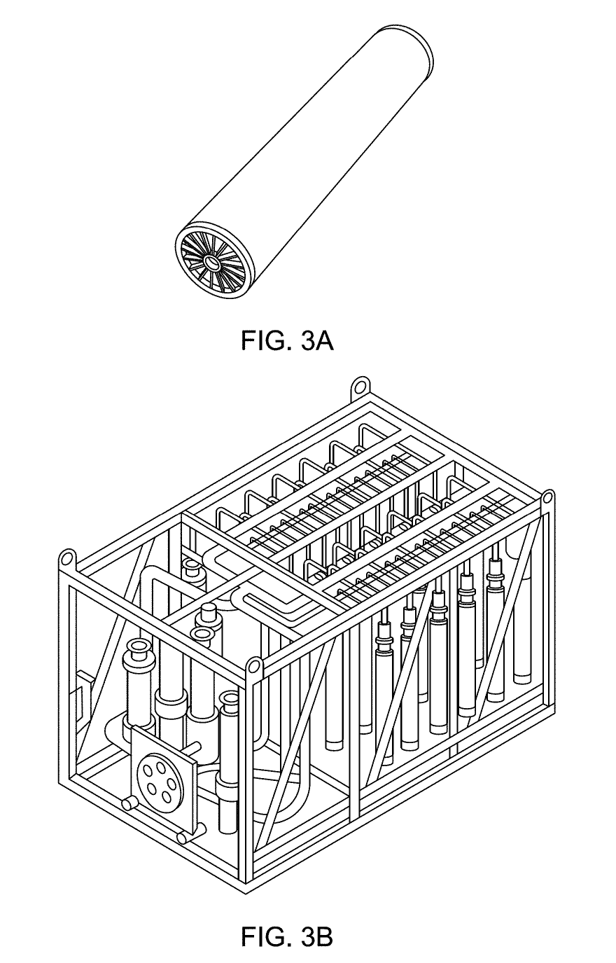

FIG. 4A illustrates an experimental flowchart for laboratory testing of the deoiling membrane and FIG. 4B illustrates a sample of the membrane;

FIG. 5 illustrates experimental results obtained in laboratory using the deoiling membrane, in the separation of the Brazilian crude oil; and

FIG. 6 illustrates the well-defined oil-water interface obtained through the use of a demulsifier of the invention (a) compared to the oil-water interface obtained through the use of another type of commercial demulsifier (b).

### DETAILED DESCRIPTION

Embodiments of the present invention relate to a system and method which solves the problem of the previous technique and allows the disposal of water produced in an underwater environment.

An embodiment of the invention herein is a modular gas/liquid-liquid separation system to be installed in the seabed, capable of treating strong emulsions, such as the Brazilian oil.

The modular underwater gas/liquid-liquid separation system according to an embodiment of the invention herein is featured by comprising gravitational separator (8) and a water polishing system consisting of deoiling membranes (9), wherein de-emulsifying agents are employed.

An embodiment of the invention herein comprises the use of gravitational separator (8) or separation unit. Embodiments herein are not limited to the use of specific separators since the system permits the use of a conventional separator even when processing strong emulsions.

Another important feature of an embodiment of the invention herein is the use of a water polishing system comprised of deoiling membranes (9) for separating waste oil dispersed in the aqueous phase in underwater gas/liquid-liquid separation systems.

The membrane separation system is already used in water purification/treatment processes in several industrial areas. However, its use in underwater treatment of oily water is unheard of.

Another embodiment of the invention herein is the use of deoiling membranes (9) in underwater gas/liquid-liquid separation systems.

Deoiling membranes (9), which are dirty water purification membranes, have the advantage over hydrocyclones of conferring to the treated water a TOG content well below 29 ppm which corresponds to the value required for disposal legislation.

Such membranes, in addition to providing acceptable solids and TOG contents, have another great advantage over hydrocyclones since they are not sensitive to process variations such as feed flow rate, pressure, temperature, droplet concentration of oil and particle size.

Thus, the use of deoiling membranes (9) gives the treated water good quality, allowing it to be discarded at sea instead of being reinjected into the process or sent to a dedicated well.

The deoiling membranes (9) according to an embodiment of the invention herein are polymeric, ceramic membranes or a combination thereof.

The deoiling membranes (9) according to an embodiment of the invention herein are preferably membranes produced from polyacrylonitrile polymers (PAN) and are extremely hydrophilic/oleophobic.

In an embodiment, the membrane used herein is the M-Series Ultrafillic* membrane from General Electric. This polymer membrane is quite resistant to contaminant solids and therefore requires little or no periodic cleaning. It is worth mentioning that underwater systems should be as simple and robust as the installation and intervention of equipment in the underwater environment are challenging and costly.

An embodiment of the invention further comprises the injection of a demulsifier at the bottom of the production well and/or in the multiphase input flow (oil/water/gas/solids) (stream 2) and/or at the inlet of the gravitational separator (8).

Such emulsifiers (emulsion breakers) are chemical additives with strong amphiphilic behavior, resulting in a well-defined oil-water interface and facilitate phase detection, level control and gravitational separator performance (8) until even for strong water-oil emulsions.

There are on the market de-emulsifiers which promote good separation of dispersed water in the oil phase and good separation of dispersed oil in the aqueous phase. Examples of demulsifiers components are polyols, epoxides, phenol formaldehyde polymers, ethylene oxide and propylene oxide.

Examples of useful demulsifiers according to an embodiment of the invention herein include ethanol, petroleum distillates, xylene, ethylbenzene, naphthalene, polymeric epoxides or mixture of at least two of these.

In accordance with an embodiment of the invention herein, demulsifiers having strong amphiphilic behavior are preferred, as are those comprising a combination of the following compounds: ethanol (from 10%-60%, preferably from 20%-40%), distillates from (from 1%-30%, preferably from 2.5%-10%), xylene (from 1%-30%, preferably from 2.5%-10%), ethylbenzene (from 0.1%-10% %, preferably 0.1%-1%), naphthalene (0.1%-10%, preferably 0.1%-1%) and polymeric epoxides (20%-80%, preferably 40%-60%).

In an embodiment, the demulsifier used in herein is PROCHEM-EB8158 from General Electric.

The demulsifiers are used in concentrations of from 10 ppm to 500 ppm, preferably from 50 ppm to 100 ppm.

The residence time required for the water/oil separation may occur in more than 15 minutes. Preferably the separation is from 2 to 20 minutes, more preferably less than or equal to 15, and most preferably, from 3 to 5 minutes.

Due to the injection of the demulsifying preferences, the residence time required for the water/oil separation becomes smaller (preferably from 3 to 5 minutes), so it is possible to achieve an optimized design for a separation system, resulting in a more compact system, and still allowing the use of a conventional gravitational separator.

With this residence time (from 3 to 5 minutes), the demulsifier does not necessarily need to be injected into the bottom of the production well, resulting in a more flexible system that can be optimized according to the needs of the site where the equipment will be installed.

The injection of the demulsifiers can occur at the bottom of the production well and/or at the multiphase input (oil/water/gas/solid) (stream 2) and/or at the inlet of the gravitational separator (8).

The multiphase inlet flow (stream 2), which comprises oil/water/gas/solids, is conducted from the production well to the gravitational separator (8) through the production column (2a).

The technology described herein allows to employ the same separation system in different oil fields for different types of oils without any relevant modifications in the equipment. Thus, once the system is qualified, it can be used in different projects without additional qualification processes, only adapting to the flow rates required for the treatment.

In an embodiment, the modular system of the underwater gas/liquid-liquid separation may be operated at temperatures of from 25° C. to 120° C., preferably from 40° C. to 90° C.; and pressure from 1 MPa (10 bar) to 30 MPa (300 bar), preferably from 10 MPa (100 bar) to 30 MPa (300 bar).

The system may comprise a known booster pump (12), located between the gravitational separator (8) and the water polishing system consisting of deoiling membranes (9).

In one embodiment of the invention herein, the modular underwater gas/liquid-liquid separation system includes one or more TOG online sensors (10), preferably two, for monitoring the quality of the water in the seabed.

The advantage of using TOG online sensors is that they allow monitoring of water, without the need for sampling, for example in the system developed by Petrobras/FMC, where the water quality analysis (TOG content) is performed on the platform.

Thus, by monitoring the water quality through the TOG online sensors, it is possible to qualify it as being suitable for disposal at sea, dedicated well shipping, or for reinjection in the gravitational separator (8).

The sensors are arranged between the gravitational separator 8 and the water polishing system consisting of deoiling membranes (9), either before or after the booster pump (12), and/or after the permeate exit (stream 5) of the water polishing system constituted by deoiling membranes (9).

Another embodiment of the invention herein is a separation method comprising the following steps:

injecting a de-emulsifier into the bottom of the production well and/or into the multiphase inlet (oil/water/gas/solids) (stream 2) and/or into the gravitational separator inlet (8);
separating the gas phase (stream 7), the water (stream 3) and the oil (stream 6) into the gravitational separator (8);
conduction of the gas phase (stream 7) and the oil (stream 6) to the floating production storage and offloading system (FPSO);
disposal of the separated water (stream 3) at the sea; or
disposal of water in dedicated well; or
inflow of the separated water (stream 3) through the water polishing system consisting of deoiling membranes (9); and when there is the inflow of the separate stream (3) through the water polishing system consisting of deoiling membranes (9), the permeate (stream 5) will be conducted for disposal at sea.

Optionally, said separation method may comprise, after step (a), a step of separating the solids from the multiphase flow performed by a desander, which is an apparatus known in the technique.

The separation method may optionally comprise at least one recirculation step of the concentrate (stream 4), waste from the polishing system, by the gravitational separator (8).

The separation method may further comprise, in a preferred embodiment, an on-line monitoring step of water quality through at least one TOG online sensor (10) located between the gravitational separator (8) and the water polishing system consisting of deoiling membranes (9), either before or after the booster pump (12), and/or after the exit of the permeate (stream 5) from the polishing system of water constituted by deoiling membranes (9).

Thus, in one embodiment of the invention herein, the separate water (stream 3) passes by the TOG online sensor (s) located between the gravitational separator (8) and the water polishing system by deoiling membranes (9) and, if the TOG content of the separated water (stream 3) is less than or equal to 29 ppm, the separated water (stream 3) can be discarded directly at sea, not having to go through the polishing process. Otherwise, the separated water (stream 3) will be conducted to steps (d2 or d3 and (e)) described above.

In another embodiment of the invention herein, the TOG online sensor (s) are located after step (d3). The permeate (stream 5) passes through TOG's online sensor (s) arranged after the water polishing system is made up of deoiling membranes (9) and, if it submits a TOG content of less than or equal to 29 ppm, the permeate (stream 5) may be discarded at sea.

A preferred embodiment of the invention herein contemplates the monitoring of water through TOG online sensors (10) arranged both before step (e) and after the permeate inlet (stream 5).

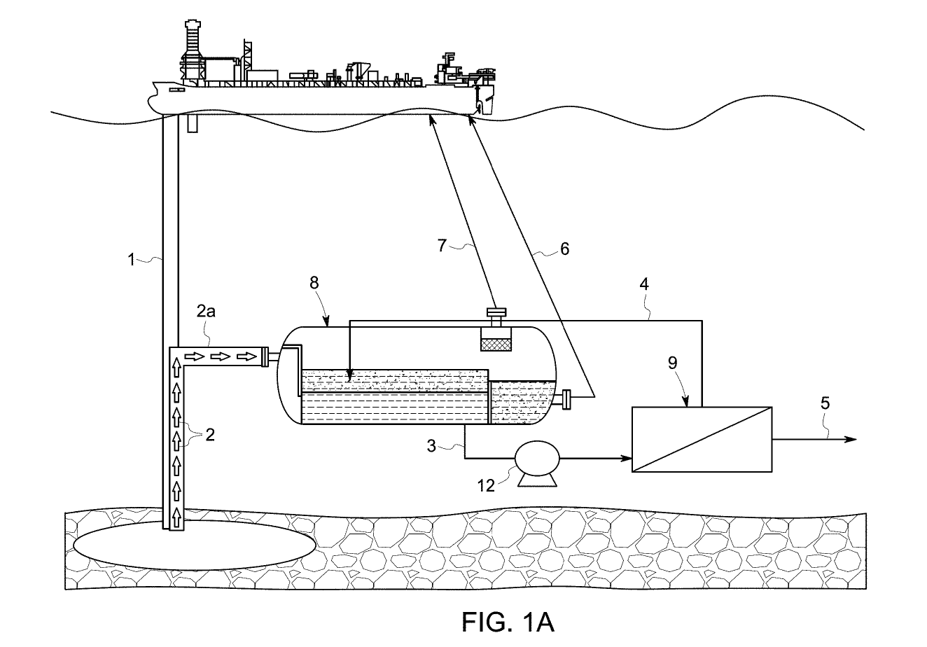

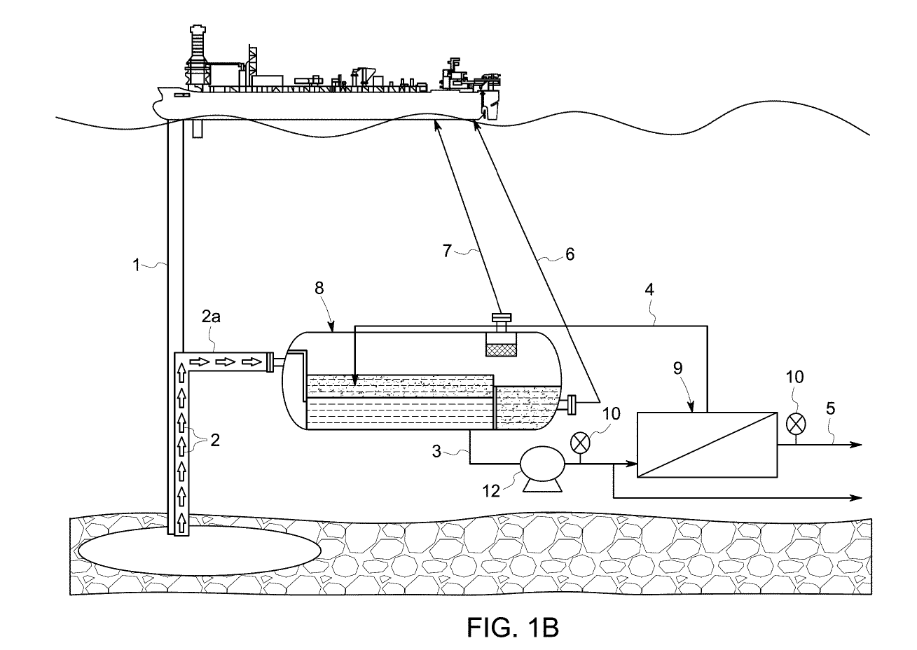

The FIG. 1B illustrates a non-limiting operational scheme of the modular underwater gas/liquid-liquid separation system according to an embodiment of the invention herein, wherein the multiphase flow (stream 2) can receive the demulsifier at the bottom of the column of production (2a).

In this figure, the demulsifier is injected using the optional gas-lift line (1).

The gas phase (stream 7) goes through the separator (8) from the top; the oil and the water (streams 6 and 3, respectively) go through tubes outputs arranged at the bottom of the separator (8).

The streams 7 and 6 are sent to the FPSO. Optionally, these streams can be sent in separate lines, or mixed in a single line, in order to reduce costs with risers, depending on the requirement of the operator.

The separate water (stream 3) can be monitored with an TOG online sensor (10). If the TOG content of the water is less than or equal to 29 ppm, the water can be discarded directly at sea.

When the TOG content of the separated water (stream 3) is greater than 29 ppm, the stream 3 is passed through the water polishing system consisting of deoiling membranes (9) to extract the residual oil. In this case, the permeate (stream 5), which has a TOG content of less than or equal to 29 ppm, is discarded at sea, and the concentrate or waste from the water polishing system consisting of deoiling membranes (stream 4) is sent back to the gravitational separator (8).

A TOG online sensor (10) may be disposed after the permeate (stream 5) from the water polishing system consisting of deoiling membranes (9) for checking the water quality.

The stream 5 may have an additional through the system, being reinjected into the gravitational separator (8) in order to obtain acceptable solids and TOG content.

The components of the present invention are illustrated below by non-exhaustive examples. The examples are merely illustrative and in no way limit the scope of the invention.

### EXAMPLES

### Example 1 GE Deoiling Mw-Series Membrane Performance Test

In order to evaluate the performance of the deoiling MW-Series membrane of GE (9) in the treatment of water produced containing oil residues laboratory tests were performed as described below.

The selected operating conditions for membrane characterization in the treatment of dispersed oil-containing produced water are listed in TABLE:

TABLE 1
EXPERIMENTAL CONDITIONS USED FOR
MEMBRANE PERFORMANCE TEST:

| | Pression | Temperature | Flow rate | Initial TOG |
|---|---|---|---|---|
| #experiment | (bar) | (° C.) | (L/h) | (mg/L) |
| 1 | 1 | 20 | 40 | 20 |
| 2 | 1 | 20 | 40 | 100 |
| 3 | 1 | 20 | 40 | 500 |
| 4 | 1 | 20 | 40 | 1000 |
| 5 | 1 | 20 | 160 | 20 |
| 6 | 1 | 20 | 160 | 100 |
| 7 | 1 | 20 | 160 | 500 |
| 8 | 1 | 20 | 160 | 1000 |
| 9 | 1 | 80 | 40 | 20 |
| 10 | 1 | 80 | 40 | 100 |
| 11 | 1 | 80 | 40 | 500 |
| 12 | 1 | 80 | 40 | 1000 |
| 13 | 1 | 80 | 160 | 20 |
| 14 | 1 | 80 | 160 | 100 |
| 15 | 1 | 80 | 160 | 500 |
| 16 | 1 | 80 | 160 | 1000 |
| 17 | 2.5 | 20 | 40 | 20 |
| 18 | 2.5 | 20 | 40 | 100 |
| 19 | 2.5 | 20 | 40 | 500 |
| 20 | 2.5 | 20 | 40 | 1000 |
| 21 | 2.5 | 20 | 160 | 20 |
| 22 | 2.5 | 20 | 160 | 100 |
| 23 | 2.5 | 20 | 160 | 500 |
| 24 | 2.5 | 20 | 160 | 1000 |
| 25 | 2.5 | 80 | 40 | 20 |
| 26 | 2.5 | 80 | 40 | 100 |
| 27 | 2.5 | 80 | 40 | 500 |
| 28 | 2.5 | 80 | 40 | 1000 |
| 29 | 2.5 | 80 | 160 | 20 |
| 30 | 2.5 | 80 | 160 | 100 |
| 31 | 2.5 | 80 | 160 | 500 |
| 32 | 2.5 | 80 | 160 | 1000 |
| 33 | 4 | 20 | 40 | 20 |
| 34 | 4 | 20 | 40 | 100 |
| 35 | 4 | 20 | 40 | 500 |
| 36 | 4 | 20 | 40 | 1000 |
| 37 | 4 | 20 | 160 | 20 |
| 38 | 4 | 20 | 160 | 100 |
| 39 | 4 | 20 | 160 | 500 |
| 40 | 4 | 20 | 160 | 1000 |
| 41 | 4 | 80 | 40 | 20 |
| 42 | 4 | 80 | 40 | 100 |
| 43 | 4 | 80 | 40 | 500 |
| 44 | 4 | 80 | 40 | 1000 |
| 45 | 4 | 80 | 160 | 20 |
| 46 | 4 | 80 | 160 | 100 |
| 47 | 4 | 80 | 160 | 500 |
| 48 | 4 | 80 | 160 | 1000 |

The permeation tests were performed with synthesized emulsion from API 12.7 crude oil, relative density (20/4° C.)=0.9774 and kinematic viscosity of 9950 mm 2/s with the actual effluent, termed as produced water.

The emulsion was synthesized using an ULTRA-TURRAX T18 disperser. Due to the high viscosity and the intense adhesion of the equipment used in its handling, the oil and water were heated to a temperature of 80° C. for the preparation of the emulsions. After heating the water was transferred to a 4 liter becher, the system was placed under shaking at 24,000 rpm and with the aid of a 100 ml becher the oil was added to the system in the form of drops. The system was left under stirring for 10 minutes.

The measurements of oil concentrations were performed on the oil and grease analyzer (OCMA-350 brand HORIBA) and total organic carbon analyzer (Shimadzu brand CPOC-V CPN).

Permeate stream and feed samples were periodically collected and analyzed to determine the separation efficiency of the membrane.

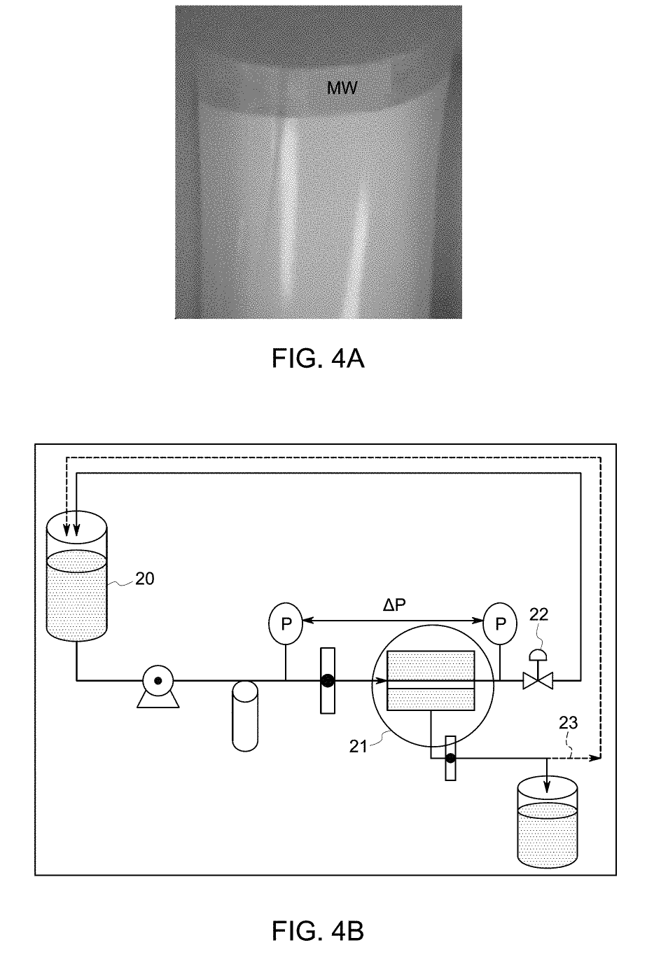

The experimental flow chart is illustrated in FIG. 4A, as well as a membrane sample tested, FIG. 4B. The test consists of a closed loop, in which different oil-water emulsions were tested.

The emulsion comprised in the feeding tank (20) is pumped through the test section of the membrane (21), whereby the permeate (22), as well as the rejected stream (23), returns to the feeding tank (20) and the emulsion is recirculated again.

The temperature is maintained constant through a bath or heat exchanger, and the pressure ports are installed downstream and upstream of the membrane module (21).

The main parameters, such as temperature, flow rate and differential pressure across the test section of the membrane (21) were varied in order to evaluate the oil/water separation efficiency as a function of these parameters. Table 1 shows the values of the parameters varied during the experiments.

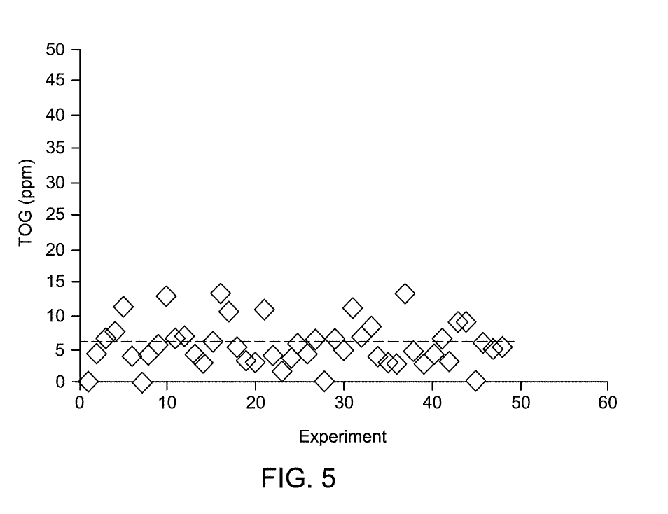

48 experiments were performed, and the TOG content of the permeate (22) remained below 15 ppm for all of them, as illustrated in FIG. 5.

### Example 2—Deployment Performance Test

In order to evaluate the performance of PROCHEM-EB8158 demulsifier developed by GE, comparative tests with other commercial de-emulsifiers were performed in the laboratory with a crude oil sample provided by Petrobras. The sample (emulsion) from the production platform P-53 (Marlim Leste) is composed of 50% water.

For testing purposes, 100 mL of the oil sample was placed in a graduated beaker and placed in a bath to keep the oil at a constant temperature of 70° C. Once a temperature of 70° C. is reached, 500 ppm of the demulsifier is added and the separated water is measured as a function of time.

Table 2 presents laboratory tests performed with an emulsion produced from the mixture P-53 (Marlim Leste) with 50% of water.

According to the results obtained, conventional demulsifiers present some results after 10 to 15 minutes. The demulsifier employed in an embodiment of the invention herein begins to act in 2 minutes and, after 16 minutes, 98% of the water dispersed in the oil phase is separated (Table 2). This feature allows for an optimized design of the separation system, with a residence time required to break down the smaller emulsion, resulting in a more compact system. This also allows flexibility at the injection point, i.e., the demulsifier does not necessarily have to be injected into the bottom of the production well, as it currently does. It can be injected to the downstream of the gravitational separator.

TABLE 2
RESULTS OF LABORATORY TESTS FOR THE DESEMULSIFIER
OF THE INVENTION WITH AN OIL MIXTURE:

| | | Separate water volume (ml) | | | | |
|---|---|---|---|---|---|---|
| | Dosage | Temperature of 70° C. | | | | |
| Product | (ppm) | 2 min. | 4 min. | 8 min. | 16 min. | 32 min. |
| Other products | 500 | 1.2 | 4 | 20 | 50 | 50 |
| found in the | 500 | 4 | 9 | 35 | 52 | 52 |
| market * | 500 | 1 | 3.5 | 10 | 40 | 50 |
| | 500 | 1 | 2 | 10 | 10 | 50 |
| PROCHEM- | 500 | 16 | 30 | 40 | 50 | 50 |
| EB8158 | | | | | | |
| Desemulsifier | | | | | | |

* Tests were performed with samples of market products used by the operators, provided for comparisons by Petrobrás, and blind efficiency tests were performed.

Thus, it is concluded that the demulsifier breaks down the strong oil-water emulsion before it enters a separator in much less time compared to other chemicals found in the market.

Another important feature of the GE demulsifier is its performance in the two phases, thus promoting the separation of dispersed water in the oil phase and the separation of dispersed oil in the aqueous phase.

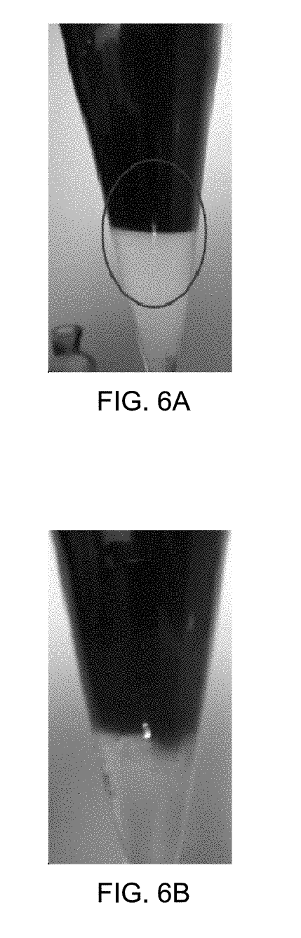

The result of this strong amphiphilic behavior is a well-defined oil-water interface, as illustrated in FIG. 6, which greatly facilitates phase detection, level control, and the performance of a gravitational separator.

It is important to note that, unlike the existing technology, the separating unit (8) herein does not depend on the type of emulsion because the strong emulsion becomes a weak dispersed system after injection of the demulsifier, which is easily manipulated by the gravitational separation system.

It is to be understood that even though numerous characteristics and advantages of various embodiments have been set forth in the foregoing description, together with details of the structure and functions of various embodiments, this disclosure is illustrative only, and changes may be made in detail, especially in matters of structure and arrangement of parts within the principles of the embodiments to the full extent indicated by the broad general meaning of the terms in which the appended claims are expressed. It will be appreciated by those skilled in the art that the teachings disclosed herein can be applied to other systems without departing from the scope and spirit of the application.

What is claimed is:

1. A gas/liquid-liquid separation system, the system comprising:
a gravitational separator; and
a water-polishing system comprising deoiling membranes, wherein de-emulsifying agents are employed and wherein the separation system is underwater.

2. The system according to claim 1, wherein the deoiling membrane is a polymeric membrane, a ceramic membrane, or a combination thereof.

3. The system according to claim 1, wherein the deoiling membrane is a polymeric membrane.

4. The system according to claim 2, wherein the deoiling membrane is produced from polyacrylonitrile polymers (PAN).

5. The system according to claim 2, wherein the deoiling membrane is M-Series Ultrafillic*.

6. The system according claim 1, wherein the demulsifier comprises a combination of the following compounds: ethanol (from 10% to 60%, preferably from 20% to 40%), petroleum distillates (from 1% to 30% preferably from 2.5% to 10%), xylene (from 1% to 30%, preferably from 2.5 to 10%), ethylbenzene (from 0.1% to 10%, preferably from 0% 1 to 1%), naphthalene (from 0.1% to 10%, preferably from 0.1 to 1%) and polymeric epoxides (from 20% to 80%, preferably 40-60%).

7. The system according to claim 1, wherein the demulsifier is PROCHEM-EB8158.

8. The system according to claim 1, wherein the demulsifiers are used in concentrations from 10 ppm to 500 ppm, preferably from 50 ppm to 100 ppm.

9. The system according to claim 1, further comprising TOG online sensors.

10. A method for underwater gas/liquid-liquid separation, the method comprising the following steps:
injecting a demulsifier at the bottom of a production well and/or at a multiphase inlet flow and/or at an inlet of the gravitational separator;
separating of the gas phase of the water and of the oil into the gravitational separator;
conducting the gas phase and the oil to a floating production storage and offloading system (FPSO);
disposing the separated water at the sea; or
disposing the separated water in a dedicated well; or
flowing the separated water through the water polishing system consisting of deoiling membranes; and
when there is an inflow of water in the system, separating water through the water polishing system consisting of deoiling membranes.

11. The method according to claim 10, further comprising recirculating concentrated waste from the polishing system by the gravitational separator.

12. The method according to claim 10, further comprising monitoring the water quality with an on-line monitoring step comprising a TOG online sensor located between the gravitational separator and the water polishing system consisting of deoiling membranes, either before or after the pusher pump, and/or after the permeate exit from the polishing water system consisting by deoiling membranes.

13. The method according to claim 10, wherein the time required for the water/oil separation to occur is about 2 to 20 minutes, more preferably less than or equal to 15 minutes.

14. The method according to claim 13, wherein the residence time required for the water/oil separation to occur is about 3 to 5 minutes.

15. A use of a deoiling membrane to be used in a gas/liquid-liquid underwater separation system comprising gravitational separator; and a water-polishing system comprising deoiling membranes, wherein de-emulsifying agents are employed and wherein the separation system is underwater.
